(19) United States
(12) Patent Application Publication
(10) Pub. No.: US 2025/0292106 A1
(43) Pub. Date: Sep. 18, 2025

(54) METHOD FOR BUILDING MODEL ACCORDING TO MODEL INFORMATION WITH SPECIFIC FORMAT AND LIBRARY SUPPORTED BY PROCESSOR

(71) Applicant: MEDIATEK INC., Hsinchu City (TW)

(72) Inventors: Ting-Ying Li, Hsinchu City (TW); Wei-Ying Wang, Hsinchu City (TW); Hsing-Yu Lung, Hsinchu City (TW); Wei-Hsu Chu, Hsinchu City (TW)

(73) Assignee: MEDIATEK INC., Hsinchu City (TW)

(21) Appl. No.: 19/012,831

(22) Filed: Jan. 7, 2025

Related U.S. Application Data
(60) Provisional application No. 63/565,580, filed on Mar. 15, 2024.

(51) Int. Cl. G06N 5/01

(52) U.S. Cl. CPC G06N 5/01

(57) ABSTRACT

A method for building a model includes: reading model information from a storage device, wherein the model information describes a user model; building the model according to the model information and a library supported by a processor; reading testing data from the storage device; and performing verification upon the model according to the testing data.

### CROSS REFERENCE TO RELATED APPLICATIONS

This application claims the benefit of U.S. Provisional Application No. 63/565,580, filed on Mar. 15, 2024. The content of the application is incorporated herein by reference.

### BACKGROUND

The present invention is related to machine learning, and more particularly, to a method that can build a model according to model information with a specific format and a library supported by a processor.

A processor may support different types of machine learning libraries, including Tensorflow, PyTorch, Open Neural Network Exchange (ONNX), and so on. When a user requires implementing a tree-based model on the processor for inference, the user typically needs to confirm a library supported by the processor and ensure that the tree-based model can be directly converted to the processor for running based on the library. Take a Scikit-learn decision tree (SK-DT) based model as an example. The SK-DT based model can directly run on a processor supporting ONNX. For a processor supporting Tensorflow, however, the SK-DT based model should be retrained by utilizing Tensorflow before running on the processor, which causes reduced design flexibility and restrictions in use.

### SUMMARY

It is therefore one of the objectives of the present invention to provide a method for building a model based on tree information with a specific format and a library supported by a processor, in order to address the above-mentioned issues.

According to an embodiment of the present invention, a method for building a model is provided. The method comprises: reading model information from a storage device, wherein the model information describes a user model; building the model according to the model information and a library supported by a processor; reading testing data from the storage device; and performing verification upon the model according to the testing data.

According to an embodiment of the present invention, a non-transitory machine-readable medium for storing a program code is provided. When loaded and executed by a processor, the program code instructs the processor to execute a processing module. The processing module is arranged to: read model information from a storage device, wherein the model information describes a user model; build a model according to the model information and a library supported by the processor; read testing data from the storage device; and perform verification upon the model according to the testing data.

One of the benefits of the present invention is that, by the method of the present invention, model information of a user model may be preloaded into a storage device, and a model can be built and verified according to a library supported by a processor and the model information, wherein the model information has a specific format (e.g., a CSV format) that can be adaptively supported by the processor. In this way, no matter whether the library of the processor supports the user model, the built model can directly run on the processor for inference without being retrained, which can greatly improve design flexibility and usage restrictions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an example of model information according to an embodiment of the present invention.

FIG. 3 is a flow chart of a method for building a model based on model information and a library supported by a processor according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

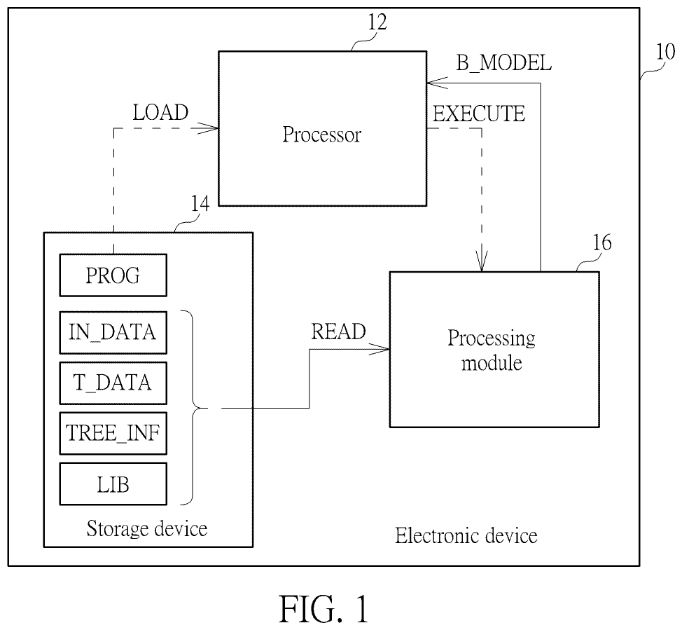

FIG. 1 is a diagram illustrating an electronic device 10 according to an embodiment of the present invention. By way of example, but not limitation, the electronic device 10 may be a tablet computer or a personal computer (e.g., a desktop computer and a laptop computer). The electronic device 10 may include a processor 12 and a storage device 14. The processor 12 may be a single-core processor or a multi-core processor. The storage device 14 is a non-transitory machine-readable medium, and is arranged to store computer program code PROG, input dataset IN_DATASET, testing dataset T_DATASET, model information TREE_INF, and a library LIB supported by the processor 12. After a user build a user model U_MODEL by utilizing a library that may be different from the library LIB and may not be supported by the processor 12, the user may then load the user model U_MODEL via the library, extract the model information TREE_INF from the user model U_MODEL, and convert a format of the model information TREE_INF into a specific format that can be supported by the processor 12 (e.g., a CSV format), wherein the model information TREE_INF with the specific format may be preloaded into the storage device 14, and may be arranged to describe the user model U_MODEL.

The processor 12 is equipped with software execution capability. The computer program code PROG may include one or more software modules. As a result, when loaded and executed by the processor 12, the computer program code PROG instructs the processor 12 to execute designated functions of the one or more software modules (labeled as “LOAD” and “EXECUTE” in FIG. 1). For example, the one or more software modules may include a processing module 16. The electronic device 10 may be regarded as a computer system using a computer program product that includes a computer-readable medium containing the computer program code PROG. That is, the processing module 16 and a method of the present invention for building a model may be embodied on the electronic device 10.

The processing module 16 may be arranged to read the input dataset IN_DATASET, the testing dataset T_DATASET, the model information TREE_INF, and the library LIB from the storage device 14 (labeled as “READ” in FIG. 1), and build a model B_MODEL according to the input dataset IN_DATASET, the model information TREE_INF, and the library LIB, wherein the model B_MODEL can directly run on the processor 12 for inference without being retrained. That is, under a situation that the library LIB does not support the user model U_MODEL, based on the model information TREE_INF related to the user model U_MODEL, the processing module 14 can still build the model B_MODEL by utilizing the library LIB. In addition, the processing module 16 may subsequently perform some verification operations upon the model B_MODEL according to the testing dataset T_DATASET in order to ensure correctness of the model B_MODEL.

Assume that the user model U_MODEL is a tree-based model and includes at least one tree, and each tree among the at least one tree includes at least one node. Examples of the user model U_MODEL may include, but are not limited to: a light gradient-boosting machine LGBM) based model, a scikit-learn decision tree (SK-DT) based model, a scikit-learn random forest (SK-RF) based model, and an extreme gradient boosting (XGBoost) based model. The model information TREE_INF with the specific format (e.g., the CSV format) may include multiple fields, and the fields may be respectively indicative of a number of the at least one tree (denoted by “n_tree”), the maximum depth of the at least one tree (denoted by “max_depth”), a number of features of the at least one tree (denoted by “n_features”), a number of classes of the at least one tree (denoted by “n_classes”), a node identity (ID) of each tree (denoted by “nodes_id”), a left child node ID of each node among the at least one node (denoted by “children_left_tree”), a right child node ID of each node (denoted by “children_right_tree”), a feature index of each node (denoted by “feature_tree”), a threshold value of each node (denoted by “threshold_tree”), a value of each node (denoted by “values_tree”), and a decision symbol of each node (denoted by “decision_tree”).

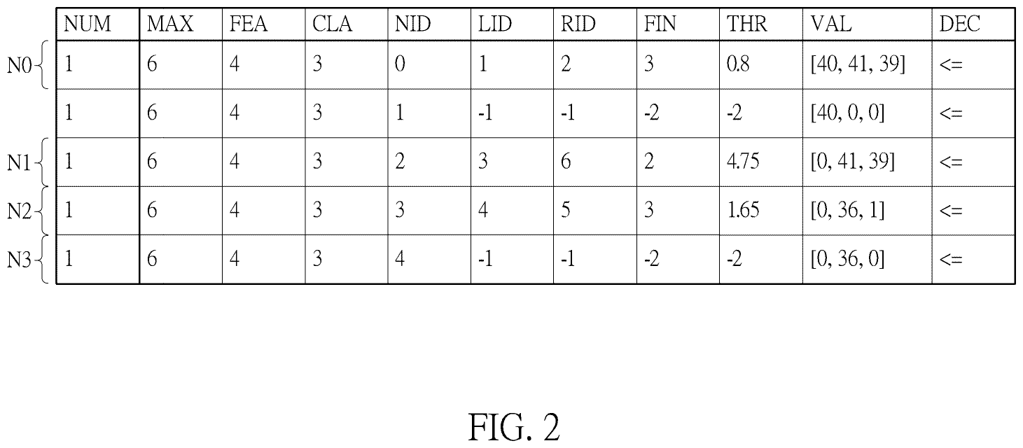

FIG. 2 is a diagram illustrating an example of the model information TREE_INF according to an embodiment of the present invention, wherein the model information TREE_INF is extracted from an SK-DT based model with multiple classes and a single tree (i.e., the SK-DT based model acts as the user model U_MODEL). The model information TREE_INF may include multiple fields related to the SK-DT based model, including a NUM field corresponding to n_tree, a MAX field corresponding to max_depth, an FEA field corresponding to n_features, a CLA field corresponding to n_classes, a NID field corresponding to nodes_id, a LID field corresponding to children_left_tree, an RID field corresponding to children_right_tree, an FIN field corresponding to feature_tree, a THR field corresponding to threshold_tree, a VAL field corresponding to values_tree, and a DEC field corresponding to decision_tree. In some embodiments, in response to the user model U_MODEL having more than one tree, fields corresponding to additional trees may be add to the right of the diagram shown in FIG. 2, and each tree can be distinguished by a tree index.

As shown in FIG. 2, n_tree, max_depth, n_features, and n_classes of the SK-DT based model are 1, 6, 4, and 3, respectively. Assume that features of input data IN_DATA within the input dataset IN_DATASET are [6.1, 2.8, 4.7, 1.2], and correspond to feature index of 0, 1, 2, and 3, respectively. In this embodiment, for better comprehension, only nodes corresponding to nodes_id “0-4” of the SK-DT based model are illustrated, but the present invention is not limited thereto. In practice, the SK-DT based model has more nodes. It should be noted that, a node with nodes_id “0” is a root node (denoted by a node N0). In addition, in response to each of children_left_tree corresponding to a node, children_right_tree corresponding to the node, feature_tree corresponding to the node, and threshold_tree corresponding to the node being less than zero, the node is determined to be a leaf node. In some embodiments, under a situation that the user model U_MODEL has multiple trees with different depths, an empty node may exist in the user model U_MODEL. Under this situation, a node may be determined to be an empty node when each of children_left_tree, children_right_tree, feature_tree, and threshold_tree of the node is less than zero.

After reading the model information TREE_INF from the storage device 14, the processing module 16 may perform at least one iteration operation according to the model information TREE_INF in order to generate an output result OUT_RES, wherein the number of performing times of the at least one iteration operation is equal to the maximum depth of the user model U_MODEL (i.e., max_depth) plus one, and the output result OUT_RES may be indicative of related description information of the at least one tree of the user model U_MODEL. In this embodiment, the number of performing times of the at least one iteration operation is equal to (6+1) times.

The at least one iteration operation starts from the root node. For each of the at least one iteration operation, a node is determined whether to head to a left child node or a right child node for a next depth according to the model information TREE_INF, until a leaf node is reached. Specifically, the processing module 16 may obtain a feature index corresponding to the node from the FIN field of the model information TREE_INF, and obtain a feature value of the input data IN_DATA according to the feature index. After obtaining the feature value of the input data IN_DATA, the processing module 16 may obtain a threshold value corresponding to the node from the THR field of the model information TREE_INF, and compare the feature value with the threshold value in order to generate a comparison result COM_RES.

According to the DEC field of the model information TREE_INF and the comparison result COM_RES, the processing module 16 may determine whether the node heads to the left child node or the right child node for the next depth. In this embodiment, decision_tree of each node (i.e., the decision symbol “<=”) represents that when the comparison result COM_RES indicates the feature value is not greater than the threshold value, the node will head to the left child node for the next depth; otherwise, the node will head to the right child node. As a result, in response to the comparison result COM_RES indicating that the feature value is greater than the threshold value, the processing module 16 may determine that the node heads to the right child node. More particularly, according to the RID field and the NID field of the model information TREE_INF, the processing module 16 may determine that the node heads to a right child node with nodes_id equal to children_right_tree of the node. In response to the comparison result COM_RES indicating that the feature value is not greater than the threshold value, the processing module 16 may determine that the node heads to the left child node. More particularly, according to the LID field and the NID field of the model information TREE_INF, the processing module 16 may determine that the node heads to a left child node with nodes_id equal to children_left_tree of the node.

For example, in this embodiment, the processing module 16 may initially obtain a feature index “3” corresponding to the root node (i.e., the node N0) from the FIN field of the model information TREE_INF, and obtain a feature value “1.2” of the input data IN_DATA according to the feature index “3”. After obtaining the feature value “1.2” of the input data IN_DATA, the processing module 16 may obtain a threshold value “0.8” corresponding to the node N0 from the THR field of the model information TREE_INF, and compare the feature value “1.2” with the threshold value “0.8” in order to generate the comparison result COM_RES. In response to the comparison result COM_RES indicating that the feature value “1.2” is greater than the threshold value “0.8”, the processing module 16 may determine that the node heads to a right child node. According to the RID field and the NID field of the model information TREE_INF, the processing module 16 may determine that the node N0 with children_right_tree “2” heads to a right child node with nodes_id “2” (denoted by a node N1).

Afterwards, the processing module 16 may obtain a feature index “2” corresponding to the node N1 from the FIN field of the model information TREE_INF, and obtain a feature value “4.7” of the input data IN_DATA according to the feature index “2”. After obtaining the feature value “4.7” of the input data IN_DATA, the processing module 16 may obtain a threshold value “4.75” corresponding to the node N1 from the THR field of the model information TREE_INF, and compare the feature value “4.7” with the threshold value “4.75” in order to generate the comparison result COM_RES. In response to the comparison result COM_RES indicating that the feature value “4.7” is not greater than the threshold value “4.75”, the processing module 16 may determine that the node heads to a left child node. According to the LID field and the NID field of the model information TREE_INF, the processing module 16 may determine that the node N1 with children_left_tree “3” heads to a left child node with nodes_id “3” (denoted by a node N2).

Afterwards, the processing module 16 may obtain a feature index “3” corresponding to the node N2 from the FIN field of the model information TREE_INF, and obtain a feature value “1.2” of the input data IN_DATA according to the feature index “3”. After obtaining the feature value “1.2” of the input data IN_DATA, the processing module 16 may obtain a threshold value “1.65” corresponding to the node N2 from the THR field of the model information TREE_INF, and compare the feature value “1.2” with the threshold value “1.65” in order to generate the comparison result COM_RES. In response to the comparison result COM_RES indicating that the feature value “1.2” is not greater than the threshold value “1.65”, the processing module 16 may determine that the node heads to a left child node. According to the LID field and the NID field of the model information TREE_INF, the processing module 16 may determine that the N2 node with children_left_tree “4” heads to a left child node with nodes_id “4” (denoted by a node N3). Since each of children_left_tree “−1”, children_right_tree “−1”, feature_tree “−2”, and threshold_tree “−2” of the node N3 is less than zero, the node N3 is determined to be a leaf node.

The VAL field of the model information TREE_INF for each node may indicate a probability of the node classified into each class. Specifically, for an SK-DT based model with multiple classes and a single tree (or an SK-RF based model with multiple classes and multiple trees), the VAL field of the model information TREE_INF may be an array, and each value in the array may represent the number of training data classified in a corresponding class. In this embodiment, the processing module 16 may determine which class the input data IN_DATA is classified into according to the VAL field corresponding to the leaf node (e.g., the node N3). Under a situation that the SK-DT based model has 3 classes class_0, class_1, and class_2, the array [0, 36, 0] in the VAL field corresponding to the node N3 may represent that when the SK-DT based model was previously trained, 36 training data classified into the class class_1 would fall on the node N3, and no training data classified into the classes class_0 or class_2 would fall on the node N3. Therefore, the input data IN_DATA may be classified into the class class_1.

For a tree-based model with a single class (e.g., an LGBM based model with a single class and multiple trees), the VAL field of the model information TREE_INF may be a single value. For an LGBM based model with multiple classes and multiple trees, the processing module 16 may be further arranged to perform a class classification operation upon the trees according to tree indexes, add up the values in the VAL field that correspond to the same class in order to generate multiple addition results, and perform a softmax operation upon each of the multiple addition results in order to obtain multiple probability values, wherein the multiple probability values correspond to the multiple classes, respectively. For example, under a situation that the number of classes is 3 (e.g., 3 classes class_0, class_1, and class_2), the processing module 16 may classify trees with tree indexes of 0, 3, 6, . . . into the class class_0, classify trees with tree indexes of 1, 4, 7, . . . into the class class_1, and classify trees with tree indexes of 2, 5, 8, . . . into the class class_2. The VAL field values of the trees in the respective class are added up in order to generate three addition results, and a softmax operation is performed upon each of the three addition results in order to obtain probability values respectively corresponding to the classes class_0, class_1, and class_2.

After the at least one iteration operation is performed, at least one value (i.e., at least one probability value) corresponding to at least one leaf node may be obtained for acting as the output result OUT_RES. The processing module 16 may then build the model B_MODEL according to the output result OUT_RES by utilizing the library LIB supported by the processor 12.

In order to ensure correctness of the model B_MODEL, the processing module 16 may read the testing dataset T_DATASET from the storage device 14, and input a feature value of testing data T_DATA within the testing dataset T_DATASET into the model B_MODEL for generating an output value OUT_V, wherein the testing data T_DATA may include a label, a probability of at least one class predicted by the user model U_MODEL, and multiple features; and the output value OUT_V may be a probability of at least one class predicted by the model B_MODEL. The label may be a ground truth GT indicating which class the testing data T_DATA belongs to. For the user model U_MODEL with multiple classes, the ground truth GT may be one of class indexes CL_INDEX_1-CL_INDEX_N (e.g., the ground truth GT may be a classification result of the testing data T_DATA), and the probability predicted by the user model U_MODEL may be an array including probability values of the testing data T_DATA classified into each class, wherein the class indexes CL_INDEX_1-CL_INDEX_N correspond to the classes, respectively, and “N” may be the number of classes minus one (i.e., N=n_classes−1). For the user model U_MODEL with a single class, the ground truth GT may be the same as a corresponding probability predicted by the user model U_MODEL, and the corresponding probability may be a single value. The processing module 16 may then compare the output value OUT_V with the ground truth GT in order to verify whether the model B_MODEL is the same as the user model U_MODEL. For example, in response to the output value OUT_V being equal to the ground truth GT, the processing module 16 may determine that the model B_MODEL is the same as the user model U_MODEL; otherwise, the processing module 16 may determine the model B_MODEL and the user model U_MODEL are not the same.

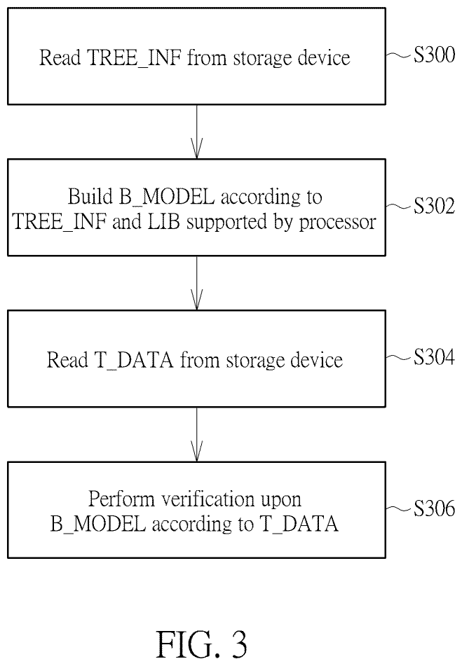

FIG. 3 is a flow chart of a method for building the model B_MODEL based on the model information TREE_INF and the library LIB supported by the processor 12 according to an embodiment of the present invention. Provided that the result is substantially the same, the steps are not required to be executed in the exact order shown in FIG. 3. For example, the method shown in FIG. 3 may be employed by the processing module 16 shown in FIG. 1. For better comprehension, the method may be illustrated with the flow shown in FIG. 3, but the present invention is not limited thereto. According to some embodiments, one or more steps may be added, deleted, or changed in the flow shown in FIG. 3.
In Step S300, the model information TREE_INF is read from the storage device 14.
In Step S302, the model B_MODEL is built according to the model information TREE_INF and the library LIB supported by the processor 12.
In Step S304, the testing data T_DATA is read from the storage device 14.
In Step S306, verification is performed upon the model B_MODEL according to the testing data T_DATA.

Since a person skilled in the pertinent art can readily understand details of the steps after reading above paragraphs, further description is omitted here for brevity.

In summary, by the method of the present invention, model information of a user model may be preloaded into a storage device, and a model can be built and verified according to a library supported by a processor and the model information, wherein the model information has a specific format (e.g., a CSV format) that can be adaptively supported by the processor. In this way, no matter whether the library of the processor supports the user model, the built model can directly run on the processor for inference without being retrained, which can greatly improve design flexibility and usage restrictions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for building a model, comprising:
reading model information from a storage device, wherein the model information describes a user model;
building the model according to the model information and a library supported by a processor;
reading testing data from the storage device; and
performing verification upon the model according to the testing data.

2. The method of claim 1, wherein the model comprises at least one tree, each tree among the at least one tree comprises at least one node, the model information comprises multiple fields, and the multiple fields are respectively indicative of a number of the at least one tree, a maximum depth of the at least one tree, a number of features of the at least one tree, a number of classes of the at least one tree, a node identity (ID) of each tree, a left child node ID of each node among the at least one node, a right child node ID of each node, a feature index of each node, a threshold value of each node, a value of each node, and a decision symbol of each node.

3. The method of claim 2, wherein in response to each of a left child node ID corresponding to a node, a right child node ID corresponding to the node, a feature index corresponding to the node, and a threshold value corresponding to the node being less than zero, the node is determined to be a leaf node.

4. The method of claim 2, wherein the value of each node indicates a probability of each node classified into each class.

5. The method of claim 2, wherein the step of building the model according to the model information and the library supported by the processor comprises:
performing at least one iteration operation according to the model information, in order to generate an output result; and
by utilizing the library supported by the processor, building the model according to the output result.

6. The method of claim 5, wherein a number of performing times of the at least one iteration operation is equal to the maximum depth plus one.

7. The method of claim 5, wherein the step of performing the at least one iteration operation according to the model information comprises:
for each of the at least one iteration operation, determining whether a node heads to a left child node or a right child node for a next depth according to the model information.

8. The method of claim 7, wherein the step of determining whether the node heads to the left child node or the right child node for the next depth according to the model information comprises:
according to a feature index corresponding the node, obtaining a feature value of input data;
comparing the feature value with a threshold value corresponding to the node, in order to generate a comparison result, wherein a decision symbol corresponding to the node indicates the comparison result; and
determining whether the node heads to the left child node or the right child node for the next depth according to the comparison result.

9. The method of claim 8, wherein the step of determining whether the node heads to the left child node or the right child node for the next depth according to the comparison result comprises:
in response to the comparison result indicating that the feature value is greater than the threshold value, determining that the node heads to the right child node, wherein a node ID corresponding to the right child node is equal to a right child node ID corresponding to the node; and
in response to the comparison result indicating that the feature value is not greater than the threshold value, determining that the node heads to the left child node, wherein a node ID corresponding to the left child node is equal to a left child node ID corresponding to the node.

10. The method of claim 5, wherein after the at least one iteration operation is performed, at least one value corresponding to at least one leaf node is obtained for acting as the output result.

11. A non-transitory machine-readable medium for storing a program code, wherein when loaded and executed by a processor, the program code instructs the processor to execute a processing module, and the processing module is arranged to:
read model information from a storage device, wherein the model information describes a user model;
build a model according to the model information and a library supported by the processor;
read testing data from the storage device; and
perform verification upon the model according to the testing data.

12. The non-transitory machine-readable medium of claim 11, wherein the model comprises at least one tree, each tree among the at least one tree comprises at least one node, the model information comprises multiple fields, and the multiple fields are respectively indicative of a number of the at least one tree, a maximum depth of the at least one tree, a number of features of the at least one tree, a number of classes of the at least one tree, a node identity (ID) of each tree, a left child node ID of each node among the at least one node, a right child node ID of each node, a feature index of each node, a threshold value of each node, a value of each node, and a decision symbol of each node.

13. The non-transitory machine-readable medium of claim 12, wherein in response to each of a left child node ID corresponding to a node, a right child node ID corresponding to the node, a feature index corresponding to the node, and a threshold value corresponding to the node being less than zero, the node is determined to be a leaf node.

14. The non-transitory machine-readable medium of claim 12, wherein the value of each node indicates a probability of each node classified into each class.

15. The non-transitory machine-readable medium of claim 12, wherein the processing module is further arranged to:
perform at least one iteration operation according to the model information, in order to generate an output result; and
by utilizing the library supported by the processor, build the model according to the output result.

16. The non-transitory machine-readable medium of claim 15, wherein a number of performing times of the at least one iteration operation is equal to the maximum depth plus one.

17. The non-transitory machine-readable medium of claim 15, wherein the processing module is further arranged to:
for each of the at least one iteration operation, determine whether a node heads to a left child node or a right child node for a next depth according to the model information.

18. The non-transitory machine-readable medium of claim 17, wherein the processing module is further arranged to:
according to a feature index corresponding the node, obtain a feature value of input data;
compare the feature value with a threshold value corresponding to the node, in order to generate a comparison result, wherein a decision symbol corresponding to the node indicates the comparison result; and
determine whether the node heads to the left child node or the right child node for the next depth according to the comparison result.

19. The non-transitory machine-readable medium of claim 18, wherein the processing module is further arranged to:
in response to the comparison result indicating that the feature value is greater than the threshold value, determine that the node heads to the right child node, wherein a node ID corresponding to the right child node is equal to a right child node ID corresponding to the node; and
in response to the comparison result indicating that the feature value is not greater than the threshold value, determine that the node heads to the left child node, wherein a node ID corresponding to the left child node is equal to a left child node ID corresponding to of the node.

20. The non-transitory machine-readable medium of claim 15, wherein after the at least one iteration operation is performed, at least one value corresponding to at least one leaf node is obtained for acting as the output result.
